(19) United States
(12) Patent Application Publication
(10) Pub. No.: US 2023/0381553 A1
(43) Pub. Date: Nov. 30, 2023

(54) SCBA Assembly with Integrated APR Capability

(71) Applicant: 3M INNOVATIVE PROPERTIES COMPANY, St. Paul, MN (US)

(72) Inventors: Judge W. Morgan, III, Oakboro, NC (US); William E. Parson, Indian Trail, NC (US); Jeffrey S. Vogus, Monroe, NC (US)

(21) Appl. No.: 18/030,879

(22) PCT Filed: Oct. 8, 2021
(86) PCT No.: PCT/IB2021/059251

§ 371 Date: Apr. 7, 2023

Related U.S. Application Data
(60) Provisional application No. 63/090,415, filed on Oct. 12, 2020.

(51) Int. Cl. A62B 18/08; A62B 7/02; A62B 7/10; A62B 9/04

(52) U.S. Cl. CPC A62B 18/086; A62B 7/02; A62B 7/10; A62B 9/04

(57) ABSTRACT

A personal protective equipment (PPE), a component for an air purifying respirator (APR) and a method for coupling an air purifying respirator (APR) to a facepiece are provided. In one embodiment, the component includes an elongate tube having a proximal end and a distal end, the distal end being configured to be in fluid communication an air filter of the APR. The component also includes an adapter disposed at the proximal end of the elongate tube. The adapter is configured to releasably fluidly couple the APR to a facepiece and releasably fluidly couple a second stage regulator of a self-contained breathing apparatus (SCBA) to the facepiece.

### TECHNICAL FIELD

This disclosure relates to personal protective equipment (PPE) and in particular to a method and system for coupling an air purifying respirator (APR) to a facepiece of PPE.

### INTRODUCTION

PPE often includes a facepiece, which releasably couples to a second stage regulator of a self-contained breathing apparatus (SCBA). However, certain conditions may require the use of an APR when air in the SCBA runs out. Currently, however, in order to attach an APR to a facepiece, the facepiece with the second stage regulator is removed from the wearer, and a new facepiece is used with the APR coupled thereto. In other configurations, the APR is coupled to the facepiece contemporaneously with, but separate from the SCBA. Such arrangements are complex, require additional openings in the facepiece and can make use uncomfortable and unwieldy.

### SUMMARY

Some embodiments advantageously provide a method and system for releasably coupling an APR to a facepiece. In one embodiment, a component for an air purifying respirator (APR) includes an elongate tube having a proximal end and a distal end, the distal end being configured to be in fluid communication an air filter of the APR. An adapter is disposed at the proximal end of the elongate tube, the adapter being configured to releasably fluidly couple the APR to a facepiece and releasably fluidly couple a second stage regulator of a self-contained breathing apparatus (SCBA) to the facepiece.

In another aspect of this embodiment, the adapter is configured to releasably mechanically couple directly to the facepiece.

In another aspect of this embodiment, the adapter includes a fluid conduit extending from the adapter and configured to be in fluid communication with a source of potable fluid.

In another aspect of this embodiment, the adapter includes a hydration switch configured to enable fluid to flow from the source of potable fluid to the fluid conduit.

In another aspect of this embodiment, the elongate tube includes a switch configured to transition the facepiece from being in fluid communication with the SCBA to being in fluid communication with the APR.

In another aspect of this embodiment, the adapter is configured to twist-lock onto the facepiece.

In another aspect of this embodiment, the second stage regulator is configured to twist-lock onto the adapter.

In another aspect of this embodiment, when the second stage regulator is releasably mechanically coupled to the adapter, the adapter and the second stage regulator are substantially co-axial.

In another aspect of this embodiment, the adapter is annular in shape.

In another aspect of this embodiment, the elongate tube is a flexible hose.

In another embodiment, personal protective equipment (PPE) includes a facepiece. A self-contained breathing apparatus (SCBA) having a second stage regulator is included. An air purifying respirator (APR) having an elongate tube and an adapter extending from the tube is included, the adapter is configured to releasably fluidly couple the APR to the facepiece and releasably fluidly couple the second stage regulator to the facepiece.

In another aspect of this embodiment, the adapter is configured to releasably mechanically couple directly to the facepiece.

In another aspect of this embodiment, the adapter includes a fluid conduit extending from the adapter and configured to be in fluid communication with a source of potable fluid.

In another aspect of this embodiment, the adapter includes a hydration switch configured to enable fluid to flow from the source of potable fluid to the fluid conduit.

In another aspect of this embodiment, the elongate tube includes a switch configured to transition the facepiece from being in fluid communication with the SCBA to being in fluid communication with the APR.

In another aspect of this embodiment, the adapter is configured to twist-lock onto the facepiece. In another aspect of this embodiment, the second stage regulator of the SCBA is configured to twist-lock onto the adapter.

In another aspect of this embodiment, when the second stage regulator is releasably mechanically coupled to the adapter, the adapter and the second stage regulator are substantially co-axial.

In another aspect of this embodiment, the adapter is annular in shape.

In another aspect of this embodiment, the second stage regulator has a first mechanical locking structure to releasably mechanically couple the second stage regulator to the adapter, and the adapter has a second mechanical locking structure to releasably mechanically couple the adapter to the facepiece in which the first mechanical structure and the second mechanical structure have the same physical arrangement.

In another embodiment, a method of coupling an air purifying respirator (APR) to a facepiece, the APR including an adapter, includes releasable coupling the adapter to the facepiece and releasably coupling a second stage regulator of a self-contained breathing apparatus to the adapter.

### BRIEF DESCRIPTION OF THE DRAWINGS

A more complete understanding of embodiments described herein, and the attendant advantages and features thereof, will be more readily understood by reference to the following detailed description when considered in conjunction with the accompanying drawings wherein:

FIG. 1 is a front perspective view of PPE constructed in accordance with the principles of the present application;

FIG. 2 is side perspective view of an APR shown in FIG. 1 FIG. 3 is a perspective view of the APR shown in FIG. 2;

FIG. 4 is a front presentive view of the PPE shown in FIG. 1 with the second stage regulator removed and the adapter of the APR shown in FIG. 2 coupled to a facepiece; and

FIG. 5 is a side-by-side view of the adapter shown in FIG. 4 (left) and the second stage regulator shown in FIG. 1 (right) showing the mechanical coupling arrangements in common between them.

### DETAILED DESCRIPTION

Before describing in detail exemplary embodiments, it is noted that the embodiments reside primarily in combinations of apparatus components and processing steps related to a method and system for coupling an APR to a facepiece of PPE. Accordingly, the system and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

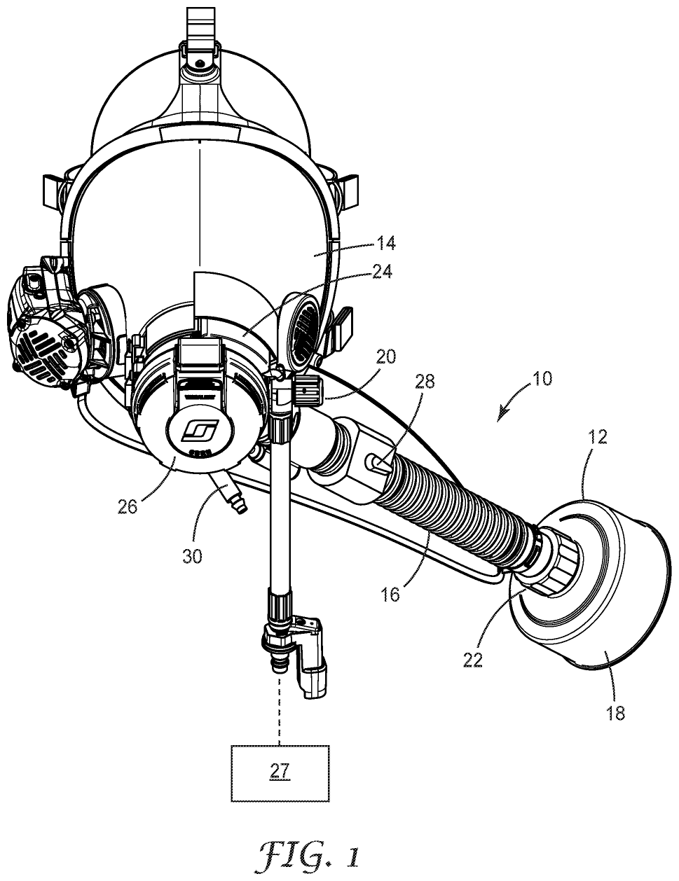

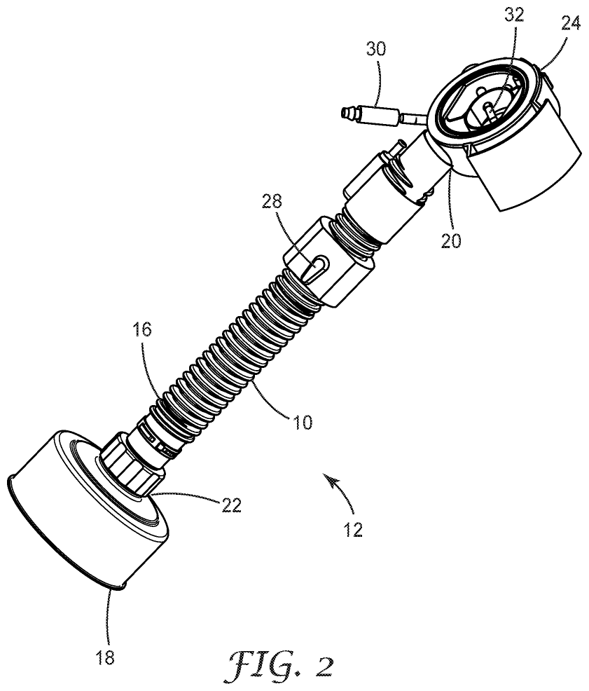

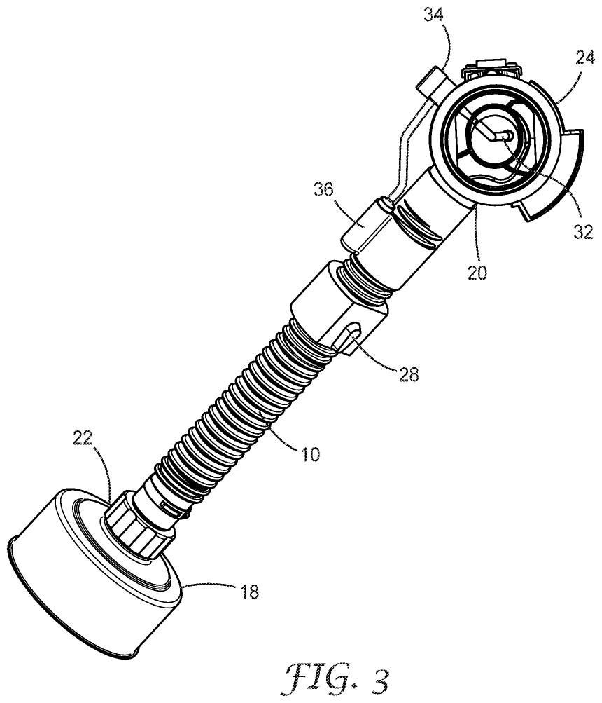

Some embodiments include a component 10 for an APR 12 configured to releasably couple the APR 12 to a facepiece 14. For example, as shown in FIGS. 1-5, the component 10 may include an elongate tube 16, which may be a flexible hose, configured to be in fluid communication with a filter 18 of the APR 12, when coupled to the filter 18, and further in fluid communication with the facepiece 14, when the component 10 is coupled to the facepiece 14. For example, in one configuration, the component 10 includes a proximal end 20 and a distal end 22. The distal end 22 is configured to couple to the filter 18 of the APR 12, which may be a passive air filter or a powered air filter. The proximal end 20 is configured to couple to an adapter 24. The facepiece 14, can be a facepiece for PPE as may be known in the art.

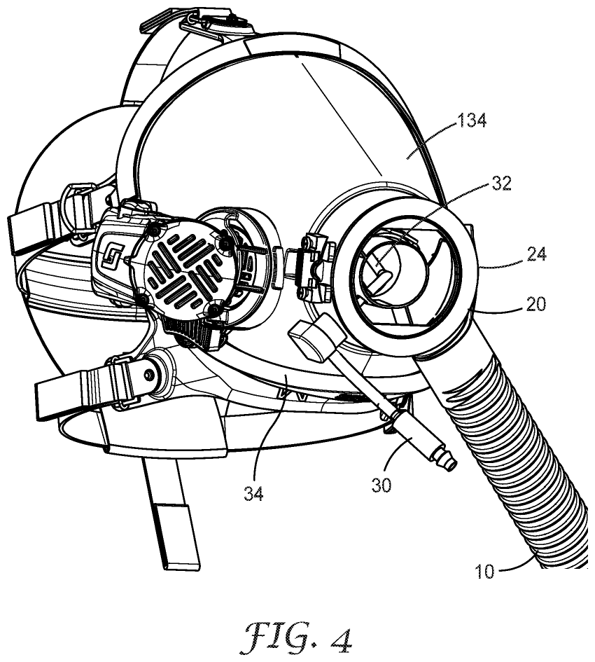

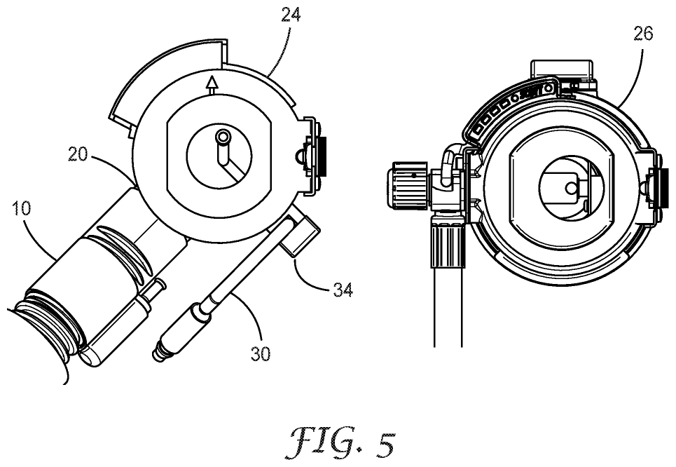

The adapter 24, which may be annular in shape in some embodiments (but is not limited to an annular shape, is configured to releasably mechanically couple to the facepiece 14. For example, the adapter 24, as shown in FIGS. 4 and 5 is configured to releasably couple to an opening in the facepiece 14 by, for example, a quarter turn twist-lock, although the adapter 24 may releasably mechanically couple to the facepiece 14 by other arrangements as may be known in the art. The twist-lock feature allows the wearer of the facepiece 14, which may be a first responder wearing gloves, to quickly and easily attach the adapter 24 to the facepiece 14 with minimal effort. The adapter 24 is further configured to releasably mechanically couple to a second stage regulator 26 of an SCBA 27. In one configuration, the wearer of the facepiece 14 releasably mechanically couples the second stage regulator 26 to the adapter 24 by the same mechanical arrangement used to couple to the adapter 24 to the facepiece 14. In particular, the second stage regulator 26 may be twist-locked onto the adapter 24. In one configuration, when the second stage regulator 26 is mechanically coupled to the adapter 24, which is coupled to the facepiece 14, the second stage regulator 26 is substantially co-axial with the adapter 24. In another configuration, the second stage regulator 26 can be directly releasably mechanically coupled directly to the facepiece 14 without the adapter 24, i.e., without the APR 12. Such an arrangement is possible because the mechanical locking structure of the adapter 24 is the same as the mechanical locking structure of the second stage regulator 26, i.e., the physical arrangement of the mechanical locking structure of the adapter 24 is the same as the mechanical locking structure of the second stage regulator 26, as shown in FIG. 5. This “stacking” arrangement advantageously reduces the number of openings needed in the facepiece 14 as compared with solutions that separately couple an APR and SCBA to the facepiece 14. This arrangement allows the adapter 24 to releasably fluidly couple the APR 12 to the facepiece 14 and releasably fluidly couple the second stage regulator 26 to the facepiece 14.

Continuing to refer to FIGS. 1-4, the elongate tube 16 includes a switch 28 configured to transition the facepiece 14 from being in fluid communication with the SCBA 27 to being in fluid communication with the APR 12. For example, in operation, the user toggles the switch 28 to switch between air delivered from the SCBA 27 through the second stage regulator 26 and air purified by the APR 12. Such situations may occur when air from the SCBA 27 runs out or in other IDLH conditions. The switch 28 may also prevent air from the SCBA 27 from flowing back through the filter 18 and the loss of breathable air from the SCBA 27. In some embodiments, the switch 28 is a mechanical valve that allows air to flow only from the APR 12 to the user, and when selected, for air to flow only from the SCBA 27.

The adapter 24 further includes a fluid conduit 30 extending from the adapter 24 and configured to be in fluid communication with a source of potable fluid (not shown). The fluid conduit 30 is further coupled to and in fluid communication with a fluid tube 32 that delivers the potable fluid, such as water, to the wearer of the adapter 24. In one configuration, the fluid tube 32 delivers water when the user bites down on the fluid tube 32 which causes the potable fluid to flow outward from the fluid tube 32. A hydration switch 34 (shown in FIGS. 3 and 4) is also included. The hydration switch 34 is configured to enable fluid to flow from the source of potable fluid to the fluid conduit 30. In one configuration, the hydration switch 34 is a mechanical valve that a wearer of the adapter 24, who is also wearing gloves, can readily actuate. Rotation of the hydration switch 34 rotates the fluid tube 32 toward a mouth of the wearer of the facepiece 14. Moreover, as shown in FIG. 3, a fluid tube housing 36 is included and coupled to the component 10.

The fluid tube housing 36 is configured to house excess length of the fluid tube 32 when the wearer applies suction to the fluid tube 32 or otherwise adjusts the length of the fluid tube 32. In one configuration, when the adapter 24 is mechanically coupled to the facepiece 14 without the second stage regulator 26, as shown in FIG. 4, the wearer of the facepiece 14 may breathe ambient air and still have access to the fluid tube 32 for hydration.

It will be appreciated by persons skilled in the art that the present embodiments are not limited to what has been particularly shown and described herein above. In addition, unless mention was made above to the contrary, it should be noted that all of the accompanying drawings are not to scale. A variety of modifications and variations are possible in light of the above teachings.

1. A component for an air purifying respirator (APR), the component comprising:
an elongate tube having a proximal end and a distal end, the distal end being configured to be in fluid communication an air filter of the APR; and
an adapter disposed at the proximal end of the elongate tube, the adapter being configured to:
releasably fluidly couple the APR to a facepiece; and
releasably fluidly couple a second stage regulator of a self-contained breathing apparatus (SCBA) to the facepiece.

2. The component of claim 1, wherein the adapter is configured to releasably mechanically couple directly to the facepiece.

3. The component of claim 1, wherein the adapter includes a fluid conduit extending from the adapter and configured to be in fluid communication with a source of potable fluid.

4. The component of claim 3, wherein the adapter includes a hydration switch configured to enable fluid to flow from the source of potable fluid to the fluid conduit.

5. The component of claim 1, wherein the elongate tube includes a switch configured to transition the facepiece from being in fluid communication with the SCBA to being in fluid communication with the APR.

6. The component of claim 1, wherein the adapter is configured to twist-lock onto the facepiece.

7. The component of claim 6, wherein the second stage regulator is configured to twist-lock onto the adapter.

8. The component of claim 1, wherein when the second stage regulator is releasably mechanically coupled to the adapter, the adapter and the second stage regulator are substantially co-axial.

9. The component of claim 1, wherein the adapter is annular in shape.

10. The component of claim 1, wherein the elongate tube is a flexible hose.

11. A personal protective equipment (PPE), comprising:
a facepiece;
a self-contained breathing apparatus (SCBA) having a second stage regulator;
an air purifying respirator (APR) having an elongate tube and an adapter extending from the tube, the adapter being configured to:
releasably fluidly couple the APR to the facepiece; and
releasably fluidly couple the second stage regulator to the facepiece.

12. The PPE of claim 11, wherein the adapter is configured to releasably mechanically couple directly to the facepiece.

13. The PPE of claim 11, wherein the adapter includes a fluid conduit extending from the adapter and configured to be in fluid communication with a source of potable fluid.

14. The PPE of claim 13, wherein the adapter includes a hydration switch configured to enable fluid to flow from the source of potable fluid to the fluid conduit.

15. The PPE of claim 11, wherein the elongate tube includes a switch configured to transition the facepiece from being in fluid communication with the SCBA to being in fluid communication with the APR.

16. The PPE of claim 11, wherein the adapter is configured to twist-lock onto the facepiece.

17. The PPE of claim 16, wherein the second stage regulator of the SCBA is configured to twist-lock onto the adapter.

18. The PPE of claim 11, wherein when the second stage regulator is releasably mechanically coupled to the adapter, the adapter and the second stage regulator are substantially co-axial.

19. The PPE of claim 11, wherein the adapter is annular in shape.

20. The PPE of claim 11, wherein the second stage regulator has a first mechanical locking structure to releasably mechanically couple the second stage regulator to the adapter, and wherein the adapter has a second mechanical locking structure to releasably mechanically couple the adapter to the facepiece, the first mechanical locking structure and the second mechanical locking structure having a same physical arrangement.

21. (canceled)
